(19) United States
(12) Patent Application Publication
(10) Pub. No.: US 2019/0342608 A1
(43) Pub. Date: Nov. 7, 2019

(54) METHODS AND SYSTEMS FOR PROVIDING UNCORRUPTED MEDIA ASSETS

(71) Applicant: ROVI GUIDES, INC., San Jose, CA (US)

(72) Inventors: Robert F. Watts, Gilroy, CA (US); Scott D. Redman, Fremont, CA (US)

(21) Appl. No.: 16/111,705

(22) Filed: Aug. 24, 2018

Related U.S. Application Data
(60) Provisional application No. 62/667,228, filed on May 4, 2018.

(51) Int. Cl. H04N 21/44; H04N 21/45; H04N 21/2343; H04N 21/845; H04N 21/433; H04N 21/4402

(52) U.S. Cl. CPC H04N 21/44016; H04N 21/4532; H04N 21/2343; H04N 21/440263; H04N 21/4334; H04N 21/44008; H04N 21/8456

(57) ABSTRACT

Methods and systems are described for a media guidance application that enable a device to repair a corrupt recording. The media guidance application identifies and replaces a corrupt first segment of a plurality of segments corresponding to a first copy of a media asset stored on a first device with a second segment of a plurality of segments corresponding to a second copy of the media asset stored on a remote device, where the second segment is an uncorrupt version of the first segment.

### CROSS-REFERENCE TO RELATED APPLICATIONS

This disclosure claims the benefit under 35 U.S.C. § 119 (e) of U.S. Provisional Application No. 62/667,228, filed on May 4, 2018, which is incorporated herein by reference in its entirety.

### BACKGROUND

In conventional systems, a user may select to record a TV program for viewing later. If an issue arises affecting the viewability of the recording, a user is oftentimes left with no choice but to wait for the program to air again or skip the program. This may result in a subpar viewing experience for the user because the user must wait for the program to air again and record it a second time or watch a partially corrupt recording.

### SUMMARY

Accordingly, methods and systems are described herein for a media guidance application that may improve the viewing experience of a user. For example, during a recording, a system may experience technical difficulties (e.g., a power outage or an issue with the tuner/antenna reception), which may lead to a partial or corrupt recording. When the user decides to view the recorded TV program, the user may discover that one or more segments of the recording are corrupt. While the corruption is limited only to a few segments, the user viewing experience is nevertheless affected. To prevent the user's viewing experience from being affected, the aforementioned media guidance application may repair the corrupt recording using other accessible copies of the media asset. Specifically, the media guidance application detects that a first segment of a first copy of the media asset is corrupt. In response to determining that the first segment is corrupt, the media guidance application searches a database listing a plurality of remote devices that have additional copies of the media asset stored. The media guidance application identifies a remote device that has a second copy of the media asset and requests a second segment of the second copy of the media asset which corresponds to the corrupt first segment. The media guidance application receives the second segment of the second copy of the media asset and replaces the corrupt first segment in the first copy of the media asset with the second segment from the second copy of the media asset. Accordingly, when the user views the recorded program at a later time, the viewing experience is improved because the corrupt first segment in the first copy of the media asset has been replaced by the uncorrupt second segment in the first copy of the media asset.

For example, the media guidance application may have a media asset recorded and stored in a memory of a first device, such as an episode of the television show “Mr. Rogers' Neighborhood.” While recording the media asset, the media guidance application may have detected a signal outage, which prevented a portion of the episode from getting recorded by the media guidance application. The media guidance application may retrieve a first segment of a copy of the media asset stored in its memory. The media guidance application may make a determination that the segment was corrupted (e.g., missing data due to a power outage) during the recording. The media guidance application, in response to determining that the first segment is corrupt, may search a database listing a plurality of remote devices that have copies of the same media asset. The media guidance application may identify, in the database, those remote devices that have a second copy of the same media asset (e.g., other media guidance applications who also recorded the same episode of the television show “Mr. Rogers' Neighborhood”). By maintaining a database that lists the plurality of remote devices that have copies of the same media asset, the media guidance application can locate copies of the media asset to address the corrupt segment.

The media guidance application, in response to identifying the remote device, may request a second segment of the second copy of the media asset which corresponds to an uncorrupt version of the first segment. The media guidance application device may receive the second segment from the remote device, and replace the first segment with the second segment in the first copy of the media asset. The media guidance application may generate for display at a display, such as a television, connected to the media guidance application, the first copy of the media asset where the first segment (i.e., the corrupt segment) has been replaced with the second segment (i.e., the uncorrupt segment). By replacing the first segment with the second segment, the viewing experience of the user is not adversely affected by the corruption.

The media guidance application may use various methods to determine whether or not a media asset (or segment of a media asset) is corrupt. In some embodiments, the media guidance application may compute a checksum for the first segment. For example, the media guidance application may compute a checksum for the segment by, for example, enumerating all 1 bits in a data portion of a segment. For example, the media guidance application may sum all of the 1 bits corresponding to video pixel data in a segment (i.e., excluding any header portion, padding, etc., in the segment) to derive a computed checksum value. The media guidance application may use the computed sum to compare the value against an expected sum (e.g., a checksum value transmitted with the segment).

The media guidance application may then compare the checksum to a checksum field included in the first segment to determine whether the first segment is corrupt. For example, the media guidance application may access data at the end of a segment (e.g., the checksum field of the segment) representative of a number of 1 bits in the segment for the comparing. The media guidance application may compare the computed checksum to the checksum field of the segment. If the media guidance application determines that the checksums are equal, the media guidance application may determine that there is no corruption in the first segment. If the checksum field of the segment does not equal the computed checksum value, the media guidance application may determine that the first segment is corrupt (i.e., at least one of the bits of the segment was flipped).

In some embodiments, the media guidance application may determine that the first segment is corrupt by using a Secure Hash Algorithm (SHA-1). In particular, the media guidance application may calculate a hash value corresponding to the first segment. Subsequently, the media guidance application may compare the calculated hash value of the first segment to a hash value corresponding to the first segment (i.e., the expected hash value corresponding to an uncorrupt version of the first segment). The media guidance application may determine that the first segment is corrupt when the first hash value differs from the hash value associated with the first segment.

In some embodiments, the media guidance application may determine that the first segment is corrupt by determining that the first segment is missing a program clock reference (PCR) or a presentation time stamp (PTS). The media guidance application may also determine that the first segment is corrupt by determining an out-of-sequence continuity counter. In some embodiments, the media guidance application may determine that the first segment is corrupt by obtaining a transport error indicator.

In some embodiments, the media guidance application may determine that the first segment is corrupt by calculating a size of the first segment of the first copy of the media asset. The media guidance application may calculate an average size of a segment corresponding to the first segment in all additional copies of the media asset. The media guidance application may compare the size of the first segment in the first copy of the media asset to the calculated average size of the segment to determine whether the first segment of the first copy of the media asset is corrupt. The media guidance application may determine that the first segment of the first copy of the media asset is corrupt when the size of the first segment differs from the average size of the segments in the additional copies of the media asset corresponding to the first segment in the first copy of the media asset.

In some embodiments, the media guidance application may set a threshold difference requirement for determining that the first segment of the first copy of the media asset is corrupt. For example, in a case where the size of the first segment is within 10% of the average size of the segments of the additional copies of the media asset corresponding to the first segment, the media guidance application may determine that the difference in size is within a tolerance range and determine that the first segment is not corrupt. A person possessing ordinary skill in the art would of course understand that the tolerance threshold may be set at any desired level. For example, in some embodiments, the media guidance application may determine that the first segment in the first copy of the media asset is corrupt when the size of the first segment differs from the average size of the segments of the additional copies of the media asset corresponding to the media asset by at least 25%.

In some embodiments, once the media guidance application determines that the first segment is corrupt, the media guidance application may identify a first playback position corresponding to the first segment in the first copy of the media asset. For example, the media guidance application may play back the segments in a sequence defined by file encoding of the first copy of the media asset. The media guidance application may buffer (e.g., store in a memory) the last uncorrupt segment and may access data corresponding to the last uncorrupt segment to identify a playback position in the first copy of the media asset. For example, the media guidance application may identify a segment number of the segment corresponding to a position in the sequence of all the segments.

In response to determining that the first segment is corrupt, the media guidance application may search a database listing a plurality of remote devices that have copies of the media asset. For example, the media guidance application may query a central database, such as a database listing a location of all the media assets that are registered to the database, to identify remote devices having copies of the same media asset. In some aspects, the media guidance application may retrieve an IP address associated with a remote device having stored a copy of the media asset from the central database. The media guidance application may generate and transmit a packet to the remote device at the retrieved IP address requesting a second segment corresponding to an uncorrupt version of the first segment. The media guidance application may query multiple devices (e.g., computers, set-top boxes, etc.) at multiple locations (e.g., IP addresses) to identify a remote device having a second copy of the media asset which has the second segment corresponding to the uncorrupt version of the first segment.

In some embodiments, the media guidance application may identify the second segment corresponding to the uncorrupt version of the first segment based on the second segment corresponding to the first playback position in the second copy of the media asset on the remote device. For example, the media guidance application may identify a segment number of the segment corresponding to a position in the sequence of all the segments in the second copy of the media asset that corresponds to the first segment in the first copy of the media asset.

In response to identifying the remote device, the media guidance application may request the second segment from the remote device having the second copy of the media asset stored thereon. The media guidance application may replace the first segment (i.e., the corrupt segment) with the second segment (i.e., the uncorrupt segment) corresponding to the first segment. For example, the media guidance application may transmit a packet to the remote device having the second copy of the media asset requesting the second segment. The media guidance application may request the second segment of the second copy of the media asset by, for example, requesting a video segment corresponding to the second copy of the media asset.

In some embodiments, the first segment and the second segment may both include time stamp information. The media guidance application may replace, at the first device, the first segment with the second segment in the first copy of the media asset based on the time stamp information included in the first segment and the second segment. The media guidance application may generate for display the second segment. For example, the media guidance application may generate for display, at a display screen connected to the media guidance application, the second segment by, for example, decoding the second segment and modifying the segment data to a format that may be rendered at a display (e.g., television) connected to the media guidance application.

In some embodiments, the media guidance application may access the second copy of the media asset where the second copy differs from the first version by at least one of media format, resolution, aspect ratio, and total media content. For example, the media guidance application may access a second copy of the media asset that may contain commercials that are not present in the first copy of the media asset (i.e., different media content). In another example, the media guidance application may access a second copy of the media asset that is encoded in a different format that the first copy of the media asset. For example, the first copy of the media asset may be encoded in an H.264 format but the second copy of the media asset may be encoded in H.265 format. The media guidance application may request the second segment of the second copy of the media asset in a third format, such as MPEG-2. The media guidance application may request a specific format to save bandwidth, minimize decoding time, increase compatibility, etc.

In some embodiments, the media guidance application may retrieve an encoding capability of the remote device and a decoding capability of the first device. For example, the media guidance application may query the remote device for a listing of formats for which the remote device is able to encode media (e.g., H.264). The media guidance application may retrieve from a memory of the first device a listing of media formats that can be decoded by the first device (e.g., H.264). The media guidance application may use the capabilities of the remote device that complement the capabilities of the first device to identify an encoding format for the second segment.

In some embodiments, the media guidance application may compare the encoding capability of the remote device to the decoding capability of the first device to identify a mutually compatible encoding format. For example, the media guidance application may determine that the remote device is capable of encoding media in H.264 format and that the first device is capable of decoding H.264 format as described above. The media guidance application may determine that H.264 is a mutually compatible encoding format since it can be encoded by the remote device and be decoded by the first device.

In some embodiments, the media guidance application may determine performance capabilities of a communication channel utilized by the first device for communication to the remote device. For example, the media guidance application may perform network tests such as a ping test or a download/upload test to determine a network latency and throughput. The media guidance application may determine an encoding parameter based on the performance capabilities. For example, the media guidance application may determine that a network is slow (e.g., a measured throughput of the network is less than a threshold minimum value for network speed). In response to determining that the network is slow, the media guidance application may determine an encoding parameter that increases encoding compressing to minimize the throughput requirement necessary to transmit the encoded media.

In some embodiments, the media guidance application may transfer, from the remote device to the first device, the second segment of the second copy of the media asset stored on the remote device encoded in the encoding format based on the encoding parameter. For example, the media guidance application may transfer from the remote device to the first device the second segment, wherein the second segment is encoded, at the remote device, in the mutually compatible encoding format using the encoding parameter (e.g., compression level as described above).

In some embodiments, the media guidance application may store a plurality of segments corresponding to the first copy of the media asset in a buffer of the first device. For example, the media guidance application may store a portion of the first copy of the media asset in a memory of the media guidance application to be able to quickly access the segments when necessary.

In some embodiments, the media guidance application may enumerate a number of segments stored in the buffer that are corrupt. For example, the media guidance application may compare a checksum, as described above, to determine if a segment of a plurality of segments stored in the buffer is corrupt. The media guidance application may proceed for each segment of the plurality of segments in the buffer to determine a number of segments in the buffer that are corrupt.

In some embodiments, the media guidance application may determine that a threshold number of segments in the buffer are corrupt. For example, the media guidance application may compare the number of corrupt segments in the buffer, as enumerated above, to a threshold maximum value of corrupt segments retrieved from memory. The media guidance application may request corresponding segments for all the segments in the buffer if the number of corrupt segments exceeds the threshold maximum to maximize playback performance.

In some embodiments, the media guidance application may share a local area network (“LAN”) with one of the remote devices. For example, the media guidance application may communicate with the remote device without accessing a wide area network (“WAN”) also accessible to the first device.

In some embodiments, the media guidance application may receive a second segment of the second copy of the media asset in a first format, wherein the second copy of the media asset was re-encoded at the remote device from a second format for streaming over a network connection between the first device and the remote device. For example, the media guidance application may receive the second segment of the remote version in a format, such as a segment encoded using H.264 standards, wherein the segment was converted at the remote device from a second format, such as Audio Video Interleave (“AVI”) format, for streaming over the network connection between the first device and the remote device. The media guidance application may request a different format to enhance system performance.

In some embodiments, the media guidance application may receive a second segment of the second copy of the media asset wherein the segment is re-encoded to at least one of a lower segment rate or lower resolution than a respective segment rate or respective resolution of the first copy of the media asset. For example, the first copy of the media asset may be encoded using the H.264 format at 4K resolution and 60 segments per second. The second segment received by the media guidance application may be encoded using H.264 at 1080p resolution and 30 segments per second. The media guidance application may automatically generate for display the segments of the second copy of the media asset in place of segments of the first copy of the media asset.

In some embodiments, the media guidance application may retrieve an additional segment of the plurality of segments corresponding to the first copy of the media asset. For example, the media guidance application may retrieve a first segment (S_{1C1}) and an additional segment (S_{2C1}) of a copy of the media asset stored in its memory. The media guidance application may make a determination that both the first segment (S_{1C1}) and the additional segment (S_{2C1}) were corrupted (e.g., missing data due to a power outage) during the recording. The media guidance application, in response to determining that the first segment (S_{1C1}) and the additional segment (S_{2C1}) are corrupt, may determine a degree of corruption of each of the first segment (S_{1C1}) and the additional segment (S_{2C1}). In some embodiments, the media guidance application may determine a degree of corruption of the first segment (S_{1C1}) and the additional segment (S_{2C1}) by comparing their sizes to corresponding segments in the additional copies of the media asset.

In response to determining that the additional segment (S_{2C1}) is more corrupt than the first segment (S_{1C1}) in the first copy of the media asset, the media guidance application may search a database listing a plurality of remote devices that have copies of the same media asset. The media guidance application may identify, in the database, those remote devices that have a second copy (C₂) of the same media asset. By maintaining a database that lists the plurality of remote devices that have copies of the same media asset, the media guidance application can locate copies of the media asset to address the corrupt segment.

The media guidance application, in response to identifying the remote device, may request a segment (S_{2C2}) of the second copy of the media asset received from the remote device (C₂) which corresponds to an uncorrupt version of the additional segment (S_{2C1}). The media guidance application device may receive the segment (S_{2C2}) from the remote device, and replace the additional segment (S_{2C1}) with the segment (S_{2C2}) in the first copy of the media asset. The media guidance application may generate for display at a display, such as a television, connected to the media guidance application, the first copy of the media asset where the additional segment (S_{2C1}) (i.e., the corrupt segment with a degree of corruption greater than that of the first segment (S_{1C1})) has been replaced with the segment (S_{2C2}) from the second copy (C₂) of the media asset received from the remote device (i.e., the uncorrupt segment). By replacing the additional segment (S_{2C1}) with the segment (S_{2C2}), the viewing experience of the user is not adversely affected by the corruption.

In some embodiments, the media guidance application may determine that the second segment from the second copy of the media asset stored on the remote device is also corrupt. For example, in the event of a power outage over a large area, every remote device may also encounter a service interruption and the additional copies of the media asset stored on those remote devices may also be corrupt. The media guidance application may nevertheless request a second segment of the second copy of the media asset which corresponds to an less corrupt version of the first segment. The media guidance application device may receive the second segment from the remote device, and replace the first segment with the second segment in the first copy of the media asset. The media guidance application may generate for display at a display, such as a television, connected to the media guidance application, the first copy of the media asset where the first segment (i.e., the corrupt segment) has been replaced with the second segment (i.e., the less corrupt segment). By replacing the first segment with the second segment, the viewing experience of the user is improved.

It should be noted that the systems, methods, apparatuses, and/or aspects described above may be applied to, or used in accordance with, other systems, methods, apparatuses, and/or aspects.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a user device receiving an uncorrupt segment in accordance with some embodiments of the disclosure;

FIG. 2 shows an illustrative example of a media guidance display that may be presented in accordance with some embodiments;

FIG. 3 shows another illustrative example of a media guidance display that may be presented in accordance with some embodiments of the disclosure;

FIG. 4 is a block diagram of an illustrative user equipment device in accordance with some embodiments of the disclosure;

FIG. 5 is a block diagram of an illustrative media system in accordance some embodiments of the disclosure;

FIG. 6 is a flowchart of illustrative steps for identifying a corrupt segment of a media asset to be replaced by an uncorrupt segment in accordance with some embodiments of the disclosure;

FIG. 7 is a flowchart of illustrative steps for identifying a corrupt segment of a media asset in accordance with some embodiments of the disclosure;

FIG. 8 is another flowchart of illustrative steps for identifying a corrupt segment of a media asset in accordance with some embodiments of the disclosure;

FIG. 9 is another flowchart of illustrative steps for identifying a corrupt segment of a media asset in accordance with some embodiments of the disclosure;

FIG. 10 is a flowchart of illustrative steps for determining which of a plurality of corrupt segments of a media asset is to be replaced in accordance with an embodiment of the disclosure.

### DETAILED DESCRIPTION OF DRAWINGS

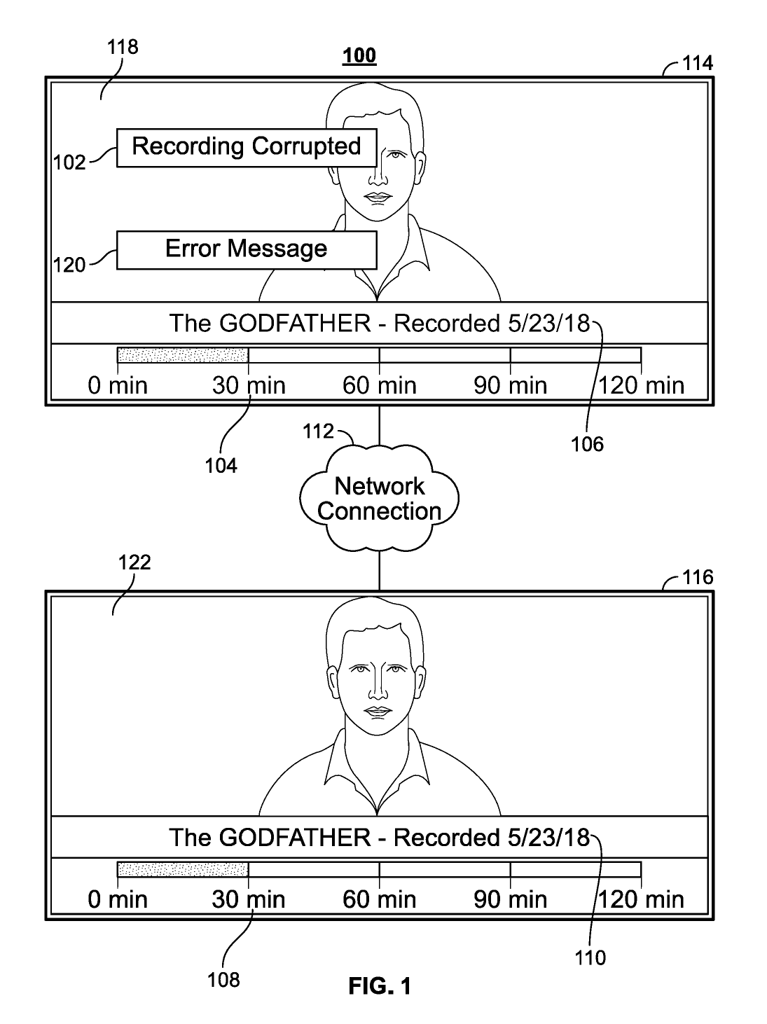

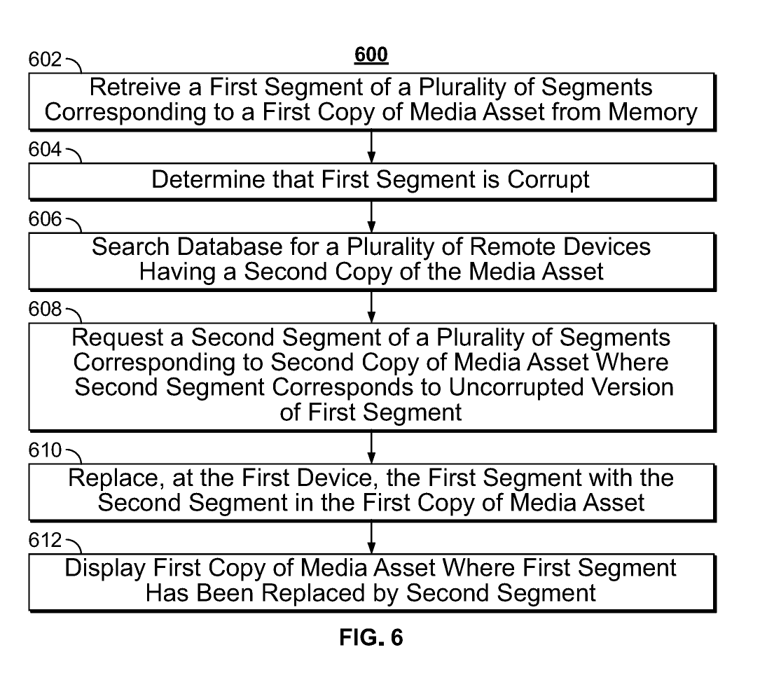

Methods and systems are described herein for a media guidance application that can repair a corrupt segment of a media asset. In particular, the media guidance application may have a media asset recorded and stored in a memory of a first device, such as the movie “The Godfather.” FIG. 1 illustrates an example of a user equipment device with a media guidance application for playing back media. In particular, FIG. 1 illustrates user equipment devices 100, such as a first device 114 and remote devices 116, for playing back media connected via network connection 112. The first device 114 may comprise a display screen, control circuitry, a user input module, a speaker, and media storage. The above components of the first devices are described in greater detail below in connection with FIG. 4.

For example, the control circuitry of the first device 114 may generate for display, on first device 114, a corrupt segment 118 containing corrupt data, such as video corruption 120. The control circuitry may generate for display playback position 104 (e.g., 30-minute mark) corresponding to a playback position of the corrupt segment 118. A title and other metadata corresponding to the media asset 106 may also be displayed on the first device 114. While recording the media asset, the media guidance application may have detected a signal outage, which prevents a portion of the movie from getting recorded by the media guidance application. In some embodiments, the media guidance application may retrieve a first segment, such as segment 118, of a copy of the media asset stored in its memory. The media guidance application may make a determination that the segment was corrupted (e.g., missing data due to a power outage) during the recording. For instance, the media guidance application may determine that the first segment 118 contains a video corruption 120.

The media guidance application, in response to determining that the first segment 118 is corrupt, may search a database listing a plurality of remote devices 116 that have copies of the same media asset. The media guidance application may identify, in the database, those remote devices 116 that have a second copy of the same media asset (e.g., other media guidance applications who also recorded the same movie, “The Godfather”). By maintaining a database that lists the plurality of remote devices that have copies of the same media asset, the media guidance application can locate copies of the media asset to address the corrupt segment. In some embodiments, the media guidance application may use network communication 112 to communicate with the database that lists the plurality of remote devices 116.

The media guidance application, in response to identifying the remote device 116, may request a second segment 122 of the second copy of the media asset, which corresponds to an uncorrupt version of the first segment 118. In some embodiments, the media guidance application may correlate playback position 104 in the first copy of the media asset stored on the first device 114 with playback position 108 in the second copy of the media asset stored on the second device 116 to determine that the second segment 122 corresponds to the first segment 118. The media guidance application device may receive the second segment 122 from the remote device 116, and replace the first segment 118 with the second segment 122 in the first copy of the media asset. The media guidance application may generate for display at a display, such as a television, connected to the media guidance application, the first copy of the media asset where the first segment 118 (i.e., the corrupt segment) has been replaced with the second segment 122 (i.e., the uncorrupt segment). By replacing the first segment 118 with the second segment 122, the viewing experience of the user is not adversely affected by the corruption.

As referred to herein, the term “replacing” means editing the first copy of the media asset to remove a corrupt segment and insert an uncorrupt segment obtained from a second copy of the media asset. For example, replacing a segment of a media asset may comprise accessing a segment of a media asset from a remote device for playback on a first device. For example, a replacement segment of a media asset may be a segment of the media asset that is re-encoded for streaming over a network connection. In another example, the media guidance application may request a replacement segment of a media asset by requesting an exact copy of the segment of a media asset that is currently being rendered at a display of a remote device.

As referred to herein, a “segment” means a portion or part of a larger group of data. For example, a segment of a song may be the first 30 seconds of a five-minute-long song. As another example, a segment may be a single image comprising a snapshot of a series of snapshots that make up a video.

As referred to herein, a “first device” is a device that may directly share multiple resources with the media guidance application. For example, a first device may be a set-top box, phone, tablet, computer, etc., running the media guidance application having a shared memory, processor, or display.

As referred to herein, a “remote device” is a device that does not directly share multiple resources with the media guidance application. For example, a remote device may be a computer on a local area network (“LAN”) connected to a device running the media guidance application. In another example, the remote device may be a cell phone accessible to the media guidance application via a wide area network (“WAN”) connection of a device running the media guidance application. In another example, the remote device may be a cell phone accessible to the media guidance application via a cloud network connected to a device running the media guidance application.

In some embodiments, a user may use a media guidance application to play back a corrupt media asset. The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application. As referred to herein, a “media guidance application” is an application that enables users to access media content through an interface.

Interactive media guidance applications may take various forms depending on the content for which they provide guidance. Media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Media guidance applications may generate graphical user interface screens that enable a user to navigate among, locate, and select content. In some examples, a media guidance application may enable a user to locate and request playback of a media asset through a graphical user interface of the media guidance application.

The media guidance application and/or any instructions for performing any of the embodiments discussed herein may be encoded on a computer readable media. Computer readable media includes any media capable of storing data. The computer readable media may be transitory, including but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memories (“RAM”) etc.

As referred to herein, the terms “media asset” and “content” should be understood to mean an electronically consumable user asset, such as television programming, as well as pay-per-view programs, on-demand programs (such as video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Media guidance applications also allow users to navigate among and locate content. As referred to herein, the term “multimedia” should be understood to mean content that uses at least two different content forms described above, for example, text, audio, video, images, or interactivity content forms. Content may be recorded, played, displayed, or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a wearable device, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), on-demand information, blogs, websites, and any other type of guidance data that is helpful for a user to navigate among and locate desired content selections.

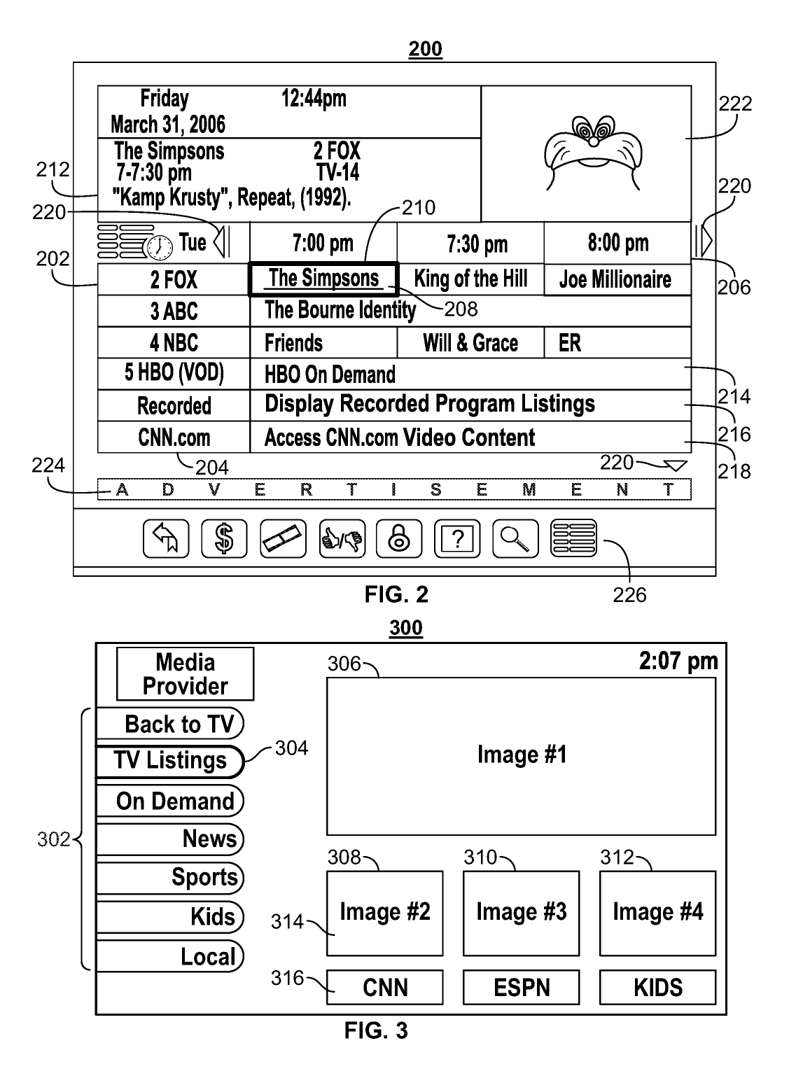

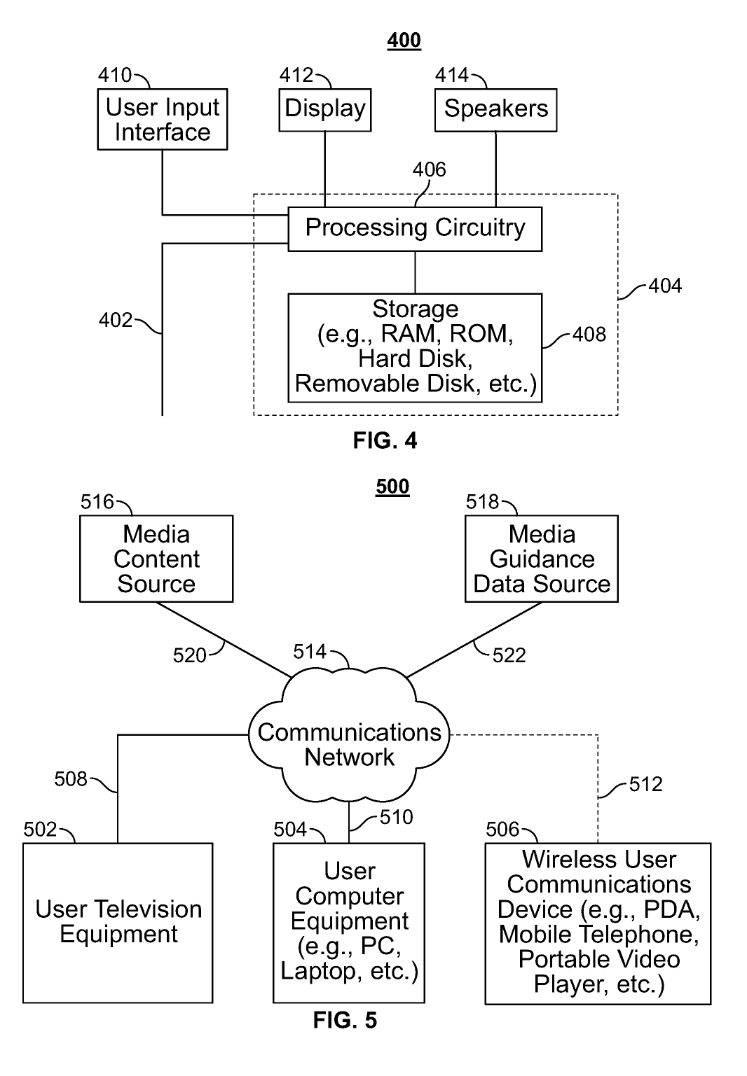

FIGS. 2-3 show illustrative display screens that may be used to provide media guidance data. The display screens shown in FIGS. 2-3 may be implemented on any suitable user equipment device or platform. While the displays of FIGS. 2-3 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or organization criteria.

FIG. 2 shows illustrative guide of a program listings display 200 arranged by time and channel that also enables access to different types of content in a single display. Display 200 may include grid 202 with: (1) a column of channel/content type identifiers 204, where each channel/content type identifier (which is a cell in the column) identifies different channel or content type available; and (2) a row of time identifiers 206, where each time identifier (which is a cell in the row) identifies a time block of programming. Grid 202 also includes cells of program listings, such as program listing 208, where each listing provides the title of the program provided on the listing's associated channel and time. With a user input device, a user can select program listings by moving highlight region 210. Information relating to the program listing selected by highlight region 210 may be provide in program information region 212. Region 212 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or Internet access (e.g., FTP).

Grid 202 may provide media guidance data for linear non-programming including on-demand listing 214, recorded content listing 216, and Internet content listing 218. A display combining media guidance data for content from different types of content sources is sometimes referred to as “mixed-media” display. Various permutations of the types of media guidance data that may be displayed that are different than display 200 may be based on user selection or guidance application definition (e.g., a display of only recorded and broadcast listings, only on-demand and broadcast listings, etc.). As illustrated, listings 214, 216, and 218 are shown spanning the entire time block displayed in grid 202 to indicated that selection of these listings may provide access to a display dedicated to on-demand listings, recorded listings, or Internet listings, respectively. In some embodiments, listings for these content types may be included directly in grid 202. Additional media guidance data may be displayed in response to the user selecting one of the navigational icons 220. (Pressing an arrow key on a user input device may affect the display in a similar manner as selecting navigational icons 220).

Display 200 may also include video region 222, and options region 224. Video region 222 may allow the user to view and/or preview programs that are currently available, will be available, or were available to the user. The content of video region 222 may correspond to, or be independent from, one of the listings displayed in grid 202. Grid displays including a video region are sometimes referred to as picture-in-guide (PIG) displays. PIG displays and their functionalities are described in greater detail in Satterfield et al. U.S. Pat. No. 6,564,378, issued May 13, 2003, and Yuen et al. U.S. Pat. No. 6,239,794, issued May 29, 2001, which are hereby incorporated by reference herein in their entireties. PIG displays may be included in other media guidance application display screens of the embodiments described herein.

Options region 224 may allow the user to access different types of content, media guidance application displays, and/or media guidance application features. Options region 224 may be part of display 200 (and other display screens described herein), or may be invoked by a user by selecting an on-screen option or pressing a dedicated or assignable button on a user input device. The selectable options within options region 224 may concern features related to program listings in grid 202 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud based options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.,), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, parental control settings, customized presentation of Internet content (e.g., presentation of social media content, e-mail, electronically delivered articles, etc.) and other desired customizations.

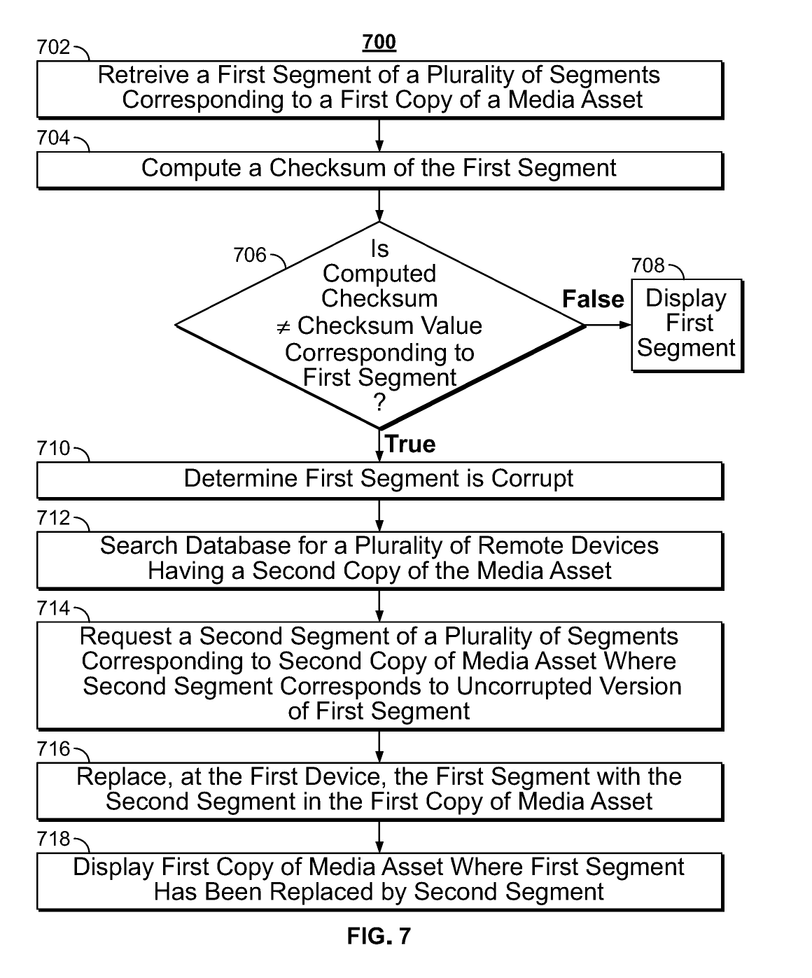

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.Tivo.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 5. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 3. Video mosaic display 300 includes selectable options 302 for content information organized based on content type, genre, and/or other organization criteria. In display 300, television listings option 304 is selected, thus providing listings 306, 308, 310, and 312 as broadcast program listings. In display 300 the listings may provide graphical images including cover art, still images from the content, video clip previews, live video from the content, other types of content that indicate to a user the content being described by the media guidance data in the listing. Each of the graphical listings may also be accompanied by text to provide further information about the content associated with the listing. For example, listing 308 may include more than one portion, including media portion 314 and text portion 316. Media portion 314 and/or text portion 316 may be selectable to view content in full-screen or to view information related to the content displayed in media portion 314 (e.g., to view listings for the channel that the video is displayed on).

The listings in display 300 are of different sizes (i.e., listing 306 is larger than listings 308, 310, and 312), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

Users may access content and the media guidance application (and its display screens described above and below) from one or more of their user equipment devices. FIG. 4 shows a generalized embodiment of illustrative user equipment device 400. More specific implementations of user equipment devices are discussed below in connection with FIG. 5. User equipment device 400 may receive content and data via input/output (hereinafter “I/O”) path 402. I/O path 402 may provide content (e.g., broadcast programming, on-demand programming, Internet content, content available over a local area network (LAN) or wide area network (WAN), and/or other content) and data to control circuitry 404, which includes processing circuitry 406 and storage 408. Control circuitry 404 may be used to send and receive commands, requests, and other suitable data using I/O path 402. I/O path 402 may connect control circuitry 404 (and specifically processing circuitry 406) to one or more communications paths (described below). I/O functions may be provided by one or more of these communications paths, but are shown as a single path in FIG. 4 to avoid overcomplicating the drawing.

Control circuitry 404 may be based on any suitable processing circuitry such as processing circuitry 406. As referred to herein, processing circuitry processing circuitry comprising circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 404 executes instructions for a media guidance application stored in memory (i.e., storage 408). Specifically, control circuitry 404 may be instructed by the media guidance application to perform the functions described above and below. For example, the media guidance application may provide instructions to control circuitry 404 to generate the media guidance displays. In some implementations, any action performed by control circuitry 404 may be based on instructions received from the media guidance application.

In client-server based embodiments, control circuitry 404 may include communications circuitry suitable for communicating with a guidance application server or other networks or servers. The instructions for carrying out the above-mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 5). In addition, communications circuitry may include circuitry that enables peer-to-peer communication of user equipment devices, or communication of user equipment devices in locations remote from each other (described in more detail below).

Memory may be an electronic storage device provided as storage 408 that is part of control circuitry 404. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 408 may be used to store various types of content described herein as well as media guidance data described above. Nonvolatile memory may also be used (e.g., to launch a boot-up routine and other instructions). Cloud-based storage, described in relation to FIG. 5, may be used to supplement storage 408 or instead of storage 408.

Control circuitry 404 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 404 may also include scalar circuitry for upconverting and downconverting content into the preferred output format for the user equipment 400. Circuitry 404 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 408 is provided as a separate device from user equipment 400, the tuning and encoding circuitry (including multiple tuners) may be associated with storage 408.

A user may send instructions to control circuitry 404 using user input interface 410. User input interface 410 may be any suitable user interface, such as a remote control, mouse, trackball, keypad, keyboard, touch screen, touchpad, stylus input, joystick, voice recognition interface, or other user input interfaces. Display 412 may be provided as a stand-alone device or integrated with other elements of user equipment device 400. For example, display 412 may be a touchscreen or touch-sensitive display. In such circumstances, user input interface 410 may be integrated with or combined with display 412. Display 412 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 412 may be HDTV-capable. In some embodiments, display 412 may be a 3D display, and the interactive media guidance application and nay suitable content may be displayed in 3D. A video card or graphics card may generate the output to the display 412. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 404. The video card may be integrated with the control circuitry 404. Speakers 414 may be provide as integrated with other elements of user equipment device 400 or may be stand-alone units. The audio component of videos and other content displayed on display 412 may be played through speakers 414. In some embodiments, the audio may be distributed to a receiver (not shown), which processes and outputs the audio via speakers 414.

The guidance application may be implemented using any suitable architecture. For example, it may be a stand-alone application wholly-implemented on user equipment device 400. In such an approach, instructions of the application are stored locally (e.g., in storage 408), and data for use by the application is downloaded on a periodic basis (e.g., from an out-of-band feed, from an Internet resource, or using another suitable approach). Control circuitry 404 may retrieve instructions of the application from storage 408 and process the instructions to generate any of the displays discussed herein. Based on the processed instructions, control circuitry 404 may determine what action to perform when input is received from input interface 410. For example, movement of a cursor on a display up/down may be indicated by the processed instructions when input interface 410 indicates that an up/down button was also selected.

In some embodiments, the media guidance application is a client-server based application. Data for use by a thick or thin client implemented on user equipment device 400 is retrieved on-demand by issuing requests to a server remote to the user equipment device 400. In one example of a client-server based guidance application, control circuitry 303 runs a web browser that interprets web pages provided by a remote server. For example, the remote server may store the instructions for the application in a storage device. The remote server may process the stored instructions using circuitry (e.g., control circuitry 404) and generate the displays discussed above and below. The client device may receive the displays generated by the remote server and may display the content of the displays locally on equipment device 400. This way, the processing of the instructions is performed remotely by the server while the resulting displays are provided locally on equipment device 400. Equipment device 400 may receive inputs from the user via input interface 410 and transmit those inputs to the remote server for processing and generating the corresponding displays. For example, equipment device 400 may transmit a communication to the remote server indicating that an up/down button was selected via input interface 410. The remote server may process instructions in accordance with that input and generate a display of the application corresponding to the input (e.g., a display that moves a cursor up/down). The generated display is then transmitted to equipment device 400 for presentation to the user.

In some embodiments, the media guidance application is downloaded and interpreted or otherwise run by an interpreter or virtual machine (run by control circuitry 404). In some embodiments, the guidance application may be encoded in the ETV Binary Interchange Format (EBIF), received by control circuitry 404 as part of a suitable feed, and interpreted by a user agent running on control circuitry 404. For example, the guidance application may be ab EBIF application. In some embodiments, the guidance application may be defined by a series of JAVA-based files that are received and run by a local virtual machine or other suitable middleware executed by control circuitry 404. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 400 of FIG. 4 can be implemented in system 500 of FIG. 5 as user television equipment 502, user computer equipment 504, wireless user communication device 506, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 4 may not be classified solely as user television equipment 502, user computer equipment 504, or a wireless user communications device 506. For example, user television equipment 502 may, like some user computer equipment 504, be Internet-enabled allowing for access to Internet content, while user computer equipment 504 may, like some television equipment 502, include a tuner allowing for access to television programming. The media guidance application may have the same layout on various different types of user equipment or may be tailored to the display capabilities of the user equipment. For example, on user computer equipment 504, the guidance application may be provided as a web site accessed by a web browser. In another example, the guidance application may be scaled down for wireless user communications device 506.

In system 500, there is typically more than one of each type of user equipment device but only one of each is shown in FIG. 5 to avoid overcomplicating the drawing. In addition, each user may utilize more than one type of user equipment device and also more than one of each type of user equipment device.

In some embodiments, a user equipment device (e.g., user television equipment 502, user computer equipment 504, wireless user communications device 506) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.Tivo.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 514. Namely, user television equipment 502, user computer equipment 504, and wireless user communications device 506 are coupled to communications network 514 via communications paths 508, 510, and 512, respectively. Communications network 514 may be one or more networks including the Internet, a mobile phone network, mobile voice or data network (e.g., a 4G or LTE network), cable network, public switched telephone network, or other types of communications network or combinations of communications networks. Paths 508, 510, and 512 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 512 is drawn with dotted lines to indicate that in the exemplary embodiment shown in FIG. 5 it is a wireless path and paths 508 and 510 are drawn as solid lines to indicate they are wired paths (although these paths may be wireless, if desired). Communications with the user equipment devices may be provided by one or more of these communications paths, but are shown as a single path in FIG. 5 to avoid overcomplicating the drawing.

Although communications paths are not drawn between user equipment devices, these devices may communicate directly with each other via communication paths, such as those described above in connection with paths 508, 510, and 512, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 514.

System 500 includes content source 516 and media guidance data source 518 coupled to communications network 514 via communication paths 520 and 520, respectively. Paths 520 and 522 may include any of the communication paths described above in connection with paths 508, 510, and 512. Communications with the content source 516 and media guidance source data source 518 may be exchanged over one or more communications paths, but are shown as a single path in FIG. 5 to avoid overcomplicating the drawing. In addition, there may be more than one of each of content source 516 and media guidance data source 518, but only one of each is shown in FIG. 5 to avoid overcomplicating the drawing. (The different types of each of these sources is discussed below.) If desired, content source 516 and media guidance data source 518 may be integrated as one source device. Although communications between sources 516 and 518 with user equipment devices 502, 504, and 506 are shown as through communications network 514, in some embodiments, sources 516 and 518 may communicate directly with user equipment devices 502, 504, and 506 via communication paths (not shown) such as those described above in connection with paths 508, 510, and 512.

Content source 516 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by Home Box Office, Inc. Content sources 516 may be the originator of content (e.g., a television broadcaster, a Webcast provider, etc.) or may not be the originator of content (e.g., an on-demand content provider, an Internet provider of content of broadcast programs for downloading, etc.). Content sources 516 may include cable sources, satellite providers, on-demand providers, Internet providers, over-the-top content providers, or other providers of content. Content source 516 may also include a remote media server user to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 518 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 518 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 518 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 518 may provide user equipment devices 502, 504, and 506 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 408, and executed by control circuitry 404 of a user equipment device 400. In some embodiments, media guidance applications may be client-server applications where only a client application resides on the user equipment device, and server application resides on a remote server. For example, media guidance applications may be implemented partially as a client application on control circuitry 404 of user equipment device 400 and partially on a remote server as a server application (e.g., media guidance data source 518) running on control circuitry of the remote server. When executed by control circuitry of the remote server (such as media guidance data source 518), the media guidance application may instruct the control circuitry to generate the guidance application displays and transmit the generated displays to the user equipment devices. The server application may instruct the control circuitry of the media guidance data source 518 to transmit data for storage on the user equipment. The client application may instruct control circuitry of the receiving user equipment to generate the guidance application displays.

Content and/or media guidance data delivered to user equipment devices 502, 504, and 506 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 500 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 5.

In one approach, user equipment devices may communicate with each other within a home network. User equipment devices can communicate with each other directly via short-range point-to-point communication schemes described above, via indirect paths through a hub or other similar device provided on a home network, or via communications network 514. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 516 to access content. Specifically, within a home, users of user television equipment 502 and user computer equipment 504 may access the media guidance application to navigate among and locate desirable content. Users may also access the media guidance application outside of the home using wireless user communications devices 506 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 514. These cloud resources may include one or more content sources 516 and one or more media guidance data sources 518. In addition or in the alternative, the remote computing sites may include other user equipment devices, such as user television equipment 502, user computer equipment 504, and wireless user communications device 506. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 504 or wireless user communications device 506 having content capture feature. Alternatively, the user can first transfer the content to a user equipment device, such as user computer equipment 504. The user equipment device storing the content uploads the content to the cloud using a data transmission service on communications network 514. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 4.

As referred to herein, the term “in response to” refers to initiated as a result of. For example, a first action being performed in response to another action may include interstitial steps between the first action and the second action. As referred to herein, the term “directly in response to” refers to caused by. For example, a first action being performed directly in response to another action may not include interstitial steps between the first action and the second action.

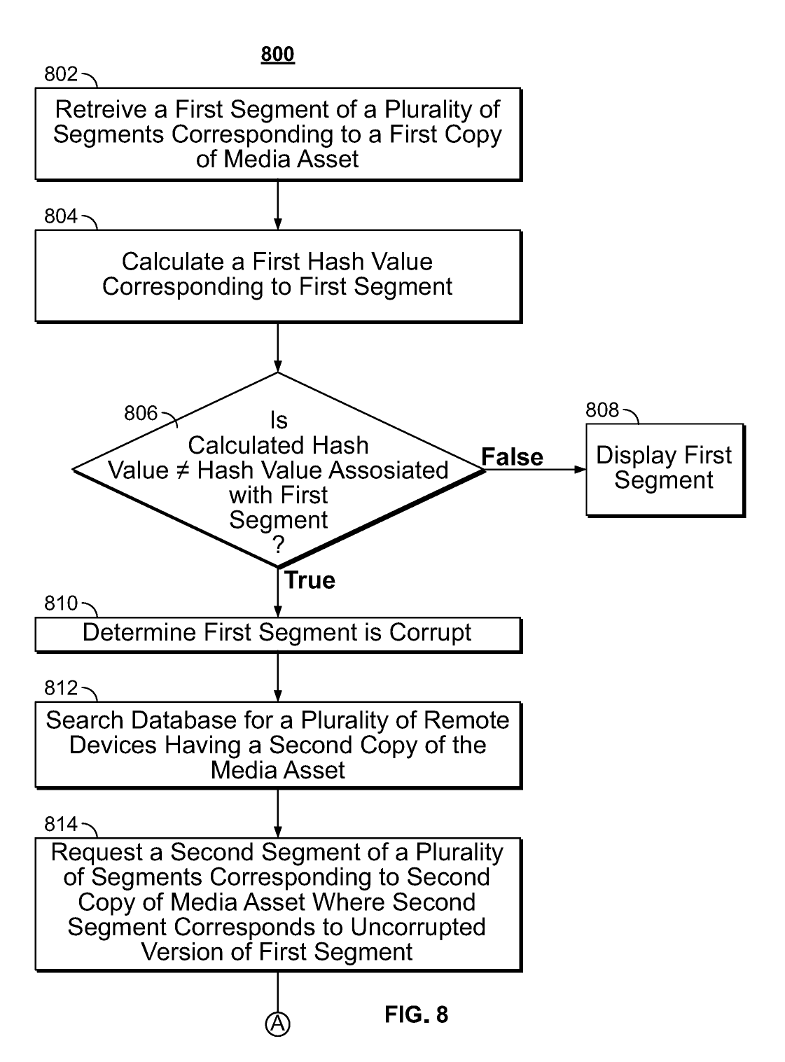

FIG. 6 is a flowchart of illustrative actions for a media guidance application, implemented on control circuitry 404, to provide uncorrupt media assets at a first device in accordance with some embodiments of the disclosure. At 602, the media guidance application, implemented on control circuitry 404, retrieves a first segment of a plurality of segments corresponding to a first copy of the media asset from a storage medium (e.g., storage 408). For example, the media guidance application may retrieve a first segment 118 of the plurality of segments corresponding to the first copy of the movie “The Godfather” from a storage medium on the first device 114.

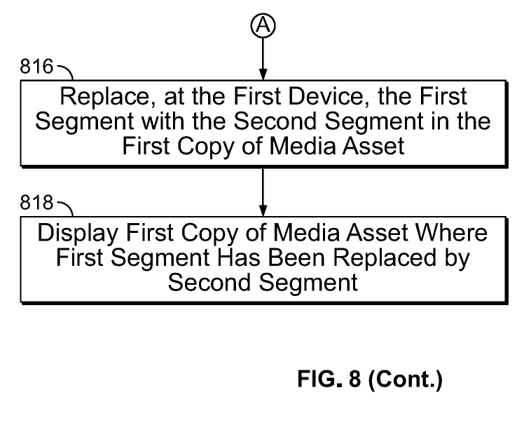

At 604, the media guidance application, implemented on control circuitry 404, may determine that a first segment is corrupt. For example, in some embodiments, the media guidance application may compute a checksum of the first segment 118. The media guidance application may compare the computed checksum of the first segment to a checksum value corresponding to the first segment, and determine that the first segment is corrupt when the computed checksum value is different from the checksum value associated with the first segment. In some embodiments, the media guidance application, implemented on control circuitry 404, may determine that the first segment is corrupt by calculating a first hash value of the first segment 118. The media guidance application may compare the calculated first hash value to a hash value corresponding to the first segment 118 and determine that the first segment is corrupt when the calculated first hash value is different from the hash value corresponding to the first segment. In some embodiments, the media guidance application, implemented on control circuitry 404, may calculate a size of the first segment 118. Moreover, the media guidance application may calculate an average size of the corresponding segments in the additional copies of the media asset, and determine that the first segment is corrupt when the calculated size of the first segment is different from the average size. Various embodiments for determining that the first segment is corrupt are described below in connection with FIGS. 7-9.

At 606, the media guidance application, implemented on control circuitry 404, in response to determining that the first segment is corrupt, may search a database listing a plurality of remote devices that have copies of the media asset to identify a remote device having a second copy of the media asset. For example, the media guidance application may search a database hosted on a cloud server that stores the contents of storage mediums (e.g., storage 408) of each of the remote devices connected to the cloud server (e.g., network connection 112). In some embodiments, the media guidance application may send a request to a cloud server for an uncorrupt copy of the media asset. The cloud server, in response to receiving the request, may send a query to all the remote devices connected to the cloud server asking for content information of their respective storage mediums (e.g., storage 408). The remote devices, in response to receiving the query from the cloud server, may transmit content information to the cloud server. For example, the remote devices may transmit the titles of the media assets and the times and dates that were stored on their respective storage mediums. The cloud server may store the incoming content information received from the plurality of remote devices into a database.

The media guidance application, in response to determining that the first segment is corrupt, may search the database storing the content information received from the plurality of remote devices to identify a remote device having a second copy of the media asset. For example, the media guidance application may identify the remote device 116 having a second copy of the movie “The Godfather” stored in its storage medium by searching the content information stored in the database.

At 608, in response to identifying the remote device, the media guidance application, implemented on control circuitry 404, may request a second segment of a plurality of segments comprising a second copy of the media asset where the second segment corresponds to an uncorrupt version of the first segment. For example, the media guidance application may identify the remote device 116 as having a second copy of the movie “The Godfather” stored thereon. The media guidance application may request an uncorrupt second segment 122 beginning at the playback position 108 (30-minute mark) corresponding to the corrupt first segment 118 beginning at the playback position 104 (30-minute mark). The media guidance application may make the request for the second segment 122 over a network connection (e.g., network connection 112). Moreover, the media guidance application, implemented on control circuitry 404, may receive the second segment 122 over the network connection 112.

At 610, the media guidance application, implemented on control circuitry 404, replaces the corrupt first segment at the first device with the second segment in the first copy of the media asset. For example, the media guidance application may edit the first copy of the media asset to remove a corrupt first segment 118 (e.g., beginning at playback position 104 of the movie “The Godfather”) and insert the second segment 122 corresponding to the first segment 118 (e.g., beginning at the playback position 108) in the first copy of the media asset at the first device 114.

At 612, the media guidance application, implemented on control circuitry 404, may generate for display the first copy of the media asset where the first segment 118 has been replaced by the second segment 122. For example, the media guidance application may generate for display on a display screen (e.g., display 412) connected to the media guidance application, a second segment of the media asset (e.g., second segment 122 beginning at playback position 108) in the first copy of the media asset on the first device 114. It will be evident to a person skilled in the art that the steps described above with reference to FIG. 6 could be performed by any other devices shown in FIGS. 4 and 5. For example, process 600 may be performed by control circuitry 404 as instructed by a media guidance application on user equipment 502, 504, 506, first device 114, or remote device 116 in order to play back media.

FIG. 7 depicts a flowchart of illustrative steps for playing back media at a user equipment device, such as the first device 114, in accordance with the present disclosure. Particularly, FIG. 7 depicts a flowchart for identifying and replacing a corrupt segment of a media asset at the first device with an uncorrupt segment from a remote device 116, where the presence of a corrupt segment is identified based on a checksum computation. At step 702, the media guidance application, via control circuitry 404, retrieves a first segment of a plurality of segments corresponding to a first copy of the media asset from a storage medium (e.g., storage 408). For example, the media guidance application may retrieve a first segment 118 of the plurality of segments corresponding to the first copy of the movie “The Godfather” from a storage medium on the first device 114.

At 704, the media guidance application, via the control circuitry 404, computes a checksum for the first segment 118. For example, control circuitry 404 may enumerate the number 1 bits in a data portion of a segment and may compare the results of the enumeration to a checksum portion of the segment. For example, the control circuitry 404 may access a checksum field of the segment. At step 706, the media guidance application, via the control circuitry 404, may check for equality against the computed checksum. If the checksums are equal, the media guidance application may determine that the segment is not corrupt (Step 708). Otherwise, at 710, the media guidance application may determine that the segment is corrupt.

At 708, in response to determining that the computed checksum is equal to the checksum of the segment, the media guidance application, via the control circuitry 404, determines that the first segment is not corrupt, and generates for display at a display screen connected to the media guidance application, the first segment. The media guidance application may then retrieve the next segment of the plurality of segments corresponding to the first copy of the media asset and begin the process again. If, at 706, the media guidance application, via the control circuitry 404, determines that the computed checksum does not equal the checksum of the segment, and therefore determines that the segment is corrupt, the processing moves to step 710.

At 710, in response to determining that the segment is corrupt, the media guidance application, via the control circuitry 404, identifies a remote device having a copy of the media asset stored thereon. At 712, the media guidance application, via the control circuitry 404, in response to determining that the first segment is corrupt, may search a database listing a plurality of remote devices that have copies of the media asset to identify a remote device having a second copy of the media asset. For example, the media guidance application may search a database hosted on a cloud server that stores the contents of storage mediums (e.g., storage 408) of each of the remote devices connected to the cloud server (e.g., network connection 112). In some embodiments, the media guidance application may send a request to a cloud server for an uncorrupt copy of the media asset. The cloud server, in response to receiving the request, may send a query to all the remote devices connected to the cloud server asking for content information of their respective storage mediums (e.g., storage 408). The remote devices, in response to receiving the query from the cloud server, may transmit content information to the cloud server. For example, the remote devices may transmit the titles of the media assets and the times and dates that were stored on their respective storage mediums. The cloud server may store the incoming content information received from the plurality of remote devices into a database.

The media guidance application, in response to determining that the first segment is corrupt, may search the database storing the content information received from the plurality of remote devices to identify a remote device having a second copy of the media asset. For example, the media guidance application may identify the remote device 116 having a second copy of the movie “The Godfather” stored in its storage medium by searching the content information stored in the database.

At 714, in response to identifying the remote device, the media guidance application, implemented on control circuitry 404, may request a second segment of a plurality of segments corresponding to a second copy of the media asset where the second segment corresponds to an uncorrupt version of the first segment. For example, the media guidance application may identify the remote device 116 as having second copy of the movie “The Godfather” stored thereon. The media guidance application may request an uncorrupt second segment 122 beginning at the playback position 108 (30-minute mark) corresponding to the corrupt first segment 118 beginning at the playback position 104 (30-minute mark). The media guidance application may make the request for the second segment 122 over a network connection (e.g., network connection 112). Moreover, the media guidance application, implemented on control circuitry 404, may receive the second segment 122 over the network connection 112.

At 716, the media guidance application, implemented on control circuitry 404, replaces the corrupt first segment at the first device with the second segment in the first copy of the media asset. For example, the media guidance application may edit the first copy of the media asset to remove a corrupt first segment 118 (e.g., beginning at playback position 104 of the movie “The Godfather”) and insert the second segment 122 corresponding to the first segment 118 (e.g., beginning at the playback position 108) in the first copy of the media asset at the first device 114.

At 718, the media guidance application, implemented on control circuitry 404, may generate for display the first copy of the media asset where the first segment 118 has been replaced by the second segment 122. For example, the media guidance application may generate for display on a display screen (e.g., display 412) connected to the media guidance application, a second segment of the media asset (e.g., second segment 122 beginning at playback position 108) in the first copy of the media asset on the first device 114.

It will be evident to a person skilled in the art that the steps described above with reference to FIG. 7 could be performed by any other devices shown in FIGS. 4 and 5. For example, process 700 may be performed by control circuitry 404 as instructed by a media guidance application on user equipment 502, 504, 506, first device 114, or remote device 116 in order to play back media. In addition, one or more steps of process 700 may be incorporated into or combined with one or more steps of any other process or embodiment (e.g., process 600).

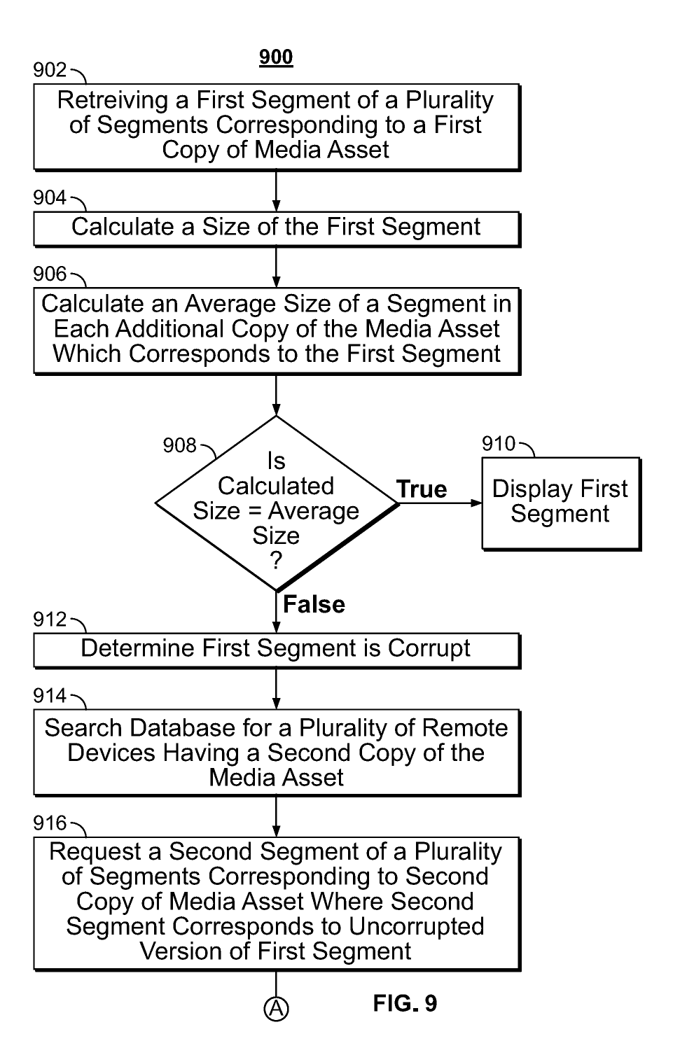

FIG. 8 depicts a flowchart of illustrative steps for playing back media at a user equipment device, such as the first device 114, in accordance with the present disclosure. Particularly, FIG. 8 depicts a flowchart for identifying and replacing a corrupt segment of a media asset at the first device with an uncorrupt segment from a remote device 116, where the presence of a corrupt segment is determined based on a hashing function. At step 802, the media guidance application, via control circuitry 404, retrieves a first segment of a plurality of segments corresponding to a first copy of the media asset from a storage medium (e.g., storage 408). For example, the media guidance application may retrieve a first segment 118 of the plurality of segments corresponding to the first copy of the movie “The Godfather” from a storage medium on the first device 114.

At 804, the media guidance application may determine that the first segment is corrupt by using a Secure Hash Algorithm (SHA-1). For example, the media guidance application, via the control circuitry 404, may calculate a hash value corresponding to the first segment. Subsequently, at 806, the media guidance application, via the control circuitry 404, may compare the calculated hash value of the first segment to a hash value corresponding to the first segment (i.e., the expected hash value corresponding to an uncorrupt version of the first segment). If the hash value assigned to an uncorrupt version of the first segment is the same as the computed hash value of the first segment, the media guidance application determines that the first segment is not corrupt. Otherwise, the media guidance application determines that the first segment is corrupt. For example, the control circuitry 404 may access a Hash ID assigned to an uncorrupt version of the first segment. At step 806, the media guidance application, via the control circuitry 404, may check for equality against the computed hash value. If the hash values are equal, the media guidance application may determine that the segment is not corrupt (Step 808). Otherwise, at 810, the media guidance application may determine that the segment is corrupt.

At 808, in response to determining that the computed hash value is equal to the assigned Hash ID of an uncorrupt version of the segment, the media guidance application, via the control circuitry 404, determines that the first segment is not corrupt, and generates for display at a display screen connected to the media guidance application, the first segment. The media guidance application may then retrieve the next segment of the plurality of segments corresponding to the first copy of the media asset and begin the process again. If, at 806, the media guidance application, via the control circuitry 404, determines that the computed hash value does not equal the assigned Hash ID of an uncorrupt version of the segment, and therefore determines that the segment is corrupt, the processing moves to step 810.

At 810, in response to determining that the segment is corrupt, the media guidance application, via the control circuitry 404, identifies a remote device having a copy of the media asset stored thereon. At 812, the media guidance application, via the control circuitry 404, in response to determining that the first segment is corrupt, may search a database listing a plurality of remote devices that have copies of the media asset to identify a remote device having a second copy of the media asset. For example, the media guidance application may search a database hosted on a cloud server that stores the contents of storage mediums (e.g., storage 408) of each of the remote devices connected to the cloud server (e.g., network connection 112). In some embodiments, the media guidance application may send a request to a cloud server for an uncorrupt copy of the media asset. The cloud server, in response to receiving the request, may send a query to all the remote devices connected to the cloud server asking for content information of their respective storage mediums (e.g., storage 408). The remote devices, in response to receiving the query from the cloud server, may transmit content information to the cloud server. For example, the remote devices may transmit the titles of the media assets and the times and dates that were stored on their respective storage mediums. The cloud server may store the incoming content information received from the plurality of remote devices into a database.

The media guidance application, in response to determining that the first segment is corrupt, may search the database storing the content information received from the plurality of remote devices to identify a remote device having a second copy of the media asset. For example, the media guidance application may identify the remote device 116 having a second copy of the movie “The Godfather” stored in its storage medium by searching the content information stored in the database.

At 814, in response to identifying the remote device, the media guidance application, implemented on control circuitry 404, may request a second segment of a plurality of segments corresponding to a second copy of the media asset where the second segment corresponds to an uncorrupt version of the first segment. For example, the media guidance application may identify the remote device 116 as having a second copy of the movie “The Godfather” stored thereon. The media guidance application may request an uncorrupt second segment 122 beginning at the playback position 108 (30-minute mark) corresponding to the corrupt first segment 118 beginning at the playback position 104 (30-minute mark). The media guidance application may make the request for the second segment 122 over a network connection (e.g., network connection 112). Moreover, the media guidance application, implemented on control circuitry 404, may receive the second segment 122 over the network connection 112.

At 816, the media guidance application, implemented on control circuitry 404, replaces the corrupt first segment at the first device with the second segment in the first copy of the media asset. For example, the media guidance application may edit the first copy of the media asset to remove a corrupt first segment 118 (e.g., beginning at playback position 104 of the movie “The Godfather”) and insert the second segment 122 corresponding to the first segment 118 (e.g., beginning at the playback position 108) in the first copy of the media asset at the first device 114.

At 818, the media guidance application, implemented on control circuitry 404, may generate for display the first copy of the media asset where the first segment 118 has been replaced by the second segment 122. For example, the media guidance application may generate for display on a display screen (e.g., display 412) connected to the media guidance application, a second segment of the media asset (e.g., second segment 122 beginning at playback position 108) in the first copy of the media asset on the first device 114.

It will be evident to a person skilled in the art that the steps described above with reference to FIG. 8 could be performed by any other devices shown in FIGS. 4 and 5. For example, process 800 may be performed by control circuitry 404 as instructed by a media guidance application on user equipment 502, 504, 506, first device 114, or remote device 116 in order to play back media. In addition, one or more steps of process 800 may be incorporated into or combined with one or more steps of any other process or embodiment (e.g., processes 600 and 700).

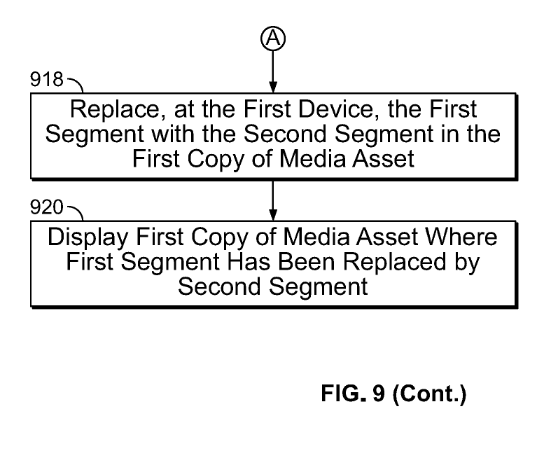

FIG. 9 depicts a flowchart of illustrative steps for playing back media at a user equipment device, such as the first device 114, in accordance with the present disclosure. Particularly, FIG. 9 depicts a flowchart for identifying and replacing a corrupt segment of a media asset at the first device with an uncorrupt segment from a remote device 116, where the presence of a corrupt segment is determined based on a comparison of the size of the segment. At step 902, the media guidance application, via control circuitry 404, retrieves a first segment of a plurality of segments corresponding to a first copy of the media asset from a storage medium (e.g., storage 408). For example, the media guidance application may retrieve a first segment 118 of the plurality of segments corresponding to the first copy of the movie “The Godfather” from a storage medium on the first device 114.

At 904, the media guidance application may determine the size of the first segment. For example, the media guidance application, via the control circuitry 404 may read a header of the segment which includes a character count indicating the number of bytes in the segment. In some embodiments, control circuitry 404 may calculate the size of the segment by using information regarding the resolution and color depth of the video segment. For example, the segment size may be calculated using the following equation (1):

segment size (bytes)=total no. of pixels×color depth (bytes) (1)

At 906, the media guidance application, via control circuitry 404, may calculate an average size of segments of the additional copies of the media asset corresponding to the first segment. For example, the media guidance application may transmit a query to a cloud server connected to the media guidance application via a first device and connected to a plurality of remote devices. The cloud server, in response to receiving the query from the first device, may identify one or more remote devices storing additional copies of the media asset, in accordance with examples discussed above and below. The cloud server, via control circuitry 404, may calculate the respective sizes of the segments in the additional copies of the media asset corresponding to the first segment. Subsequently, the media guidance application, via control circuitry, may calculate an average size of a segment in each additional copy of the media asset that corresponds to the first segment.

At 908, the media guidance application, via control circuitry 404, may run a comparison between the calculated size of the first segment and the calculated average size of the segments in each of the additional copies of the media asset corresponding to the first segment. If the calculated average size is the same as the computed size of the first segment, the media guidance application determines that the first segment is not corrupt. Otherwise, the media guidance application determines that the first segment is corrupt. At step 908, the media guidance application, via the control circuitry 404, may check for equality against the calculated average size. If the calculated sizes are equal, the media guidance application may determine that the segment is not corrupt (Step 910). Otherwise, at 912, the media guidance application may determine that the segment is corrupt.

At 910, in response to determining that the calculated size of the first segment is equal to the calculated average size of the segments in each of the additional copies of the media asset corresponding to the first segment, the media guidance application, via the control circuitry 404, determines that the first segment is not corrupt, and generates for display, at a display screen connected to the media guidance application, the first segment. The media guidance application may then retrieve the next segment of the plurality of segments corresponding to the first copy of the media asset and begin the process again. If, at 908, the media guidance application, via the control circuitry 404, determines that the calculated size of the first segment is not equal to the calculated average size of the segments in each of the additional copies of the media asset corresponding to the first segment, and therefore determines that the segment is corrupt, the processing moves to step 912.

In some embodiments, the media guidance application may determine a tolerance range for a difference between the calculated size of the first segment and the calculated average size of the segments in each of the additional copies of the media asset corresponding to the first segment. For example, the media guidance application may determine that when the calculated size of the first segment is within a preset amount of the calculated average size of the segments in each of the additional copies of the media asset corresponding to the first segment, the first segment is not corrupt. This allows the system to be more efficient since it prioritizes the identification and replacement of segments which are most damaged. For example, if the first segment only has minor video corruption whereas a subsequent segment has significantly more video corruption, the system prioritizes replacing the subsequent segment with greater corruption, thus improving the user viewing experience.

In some embodiments, the media guidance application may complete a first pass analysis of the plurality of segments corresponding to the first copy of the media asset to identify one or more segments having a size that varies by more than a preset amount (e.g., 10% or greater) than the calculated average size of the segments in each of the additional copies of the media asset corresponding to the one or more segments. The media guidance application may prioritize replacing the identified one or more segments with greater video corruption with a corresponding uncorrupt version of the one or more segments before returning to replace the remaining segments with minor corruption. The above processing has the benefit of providing the user with a better viewing experience while making the media asset available for viewing more quickly. It will be evident to a person skilled in the art that the above numerical values are provided for illustration purposes only, and any suitable percentage values may be set. For example, in some embodiments, a user selectable option may be provided giving the users control over the above processing.

Returning to FIG. 9, at 912, in response to determining that the segment is corrupt, the media guidance application, via the control circuitry 404, identifies a remote device having a copy of the media asset stored thereon. At 914, the media guidance application, via the control circuitry 404, in response to determining that the first segment is corrupt, may search a database listing a plurality of remote devices that have copies of the media asset to identify a remote device having a second copy of the media asset. For example, the media guidance application may search a database hosted on a cloud server that stores the contents of storage mediums (e.g., storage 408) of each of the remote devices connected to the cloud server (e.g., network connection 112). In some embodiments, the media guidance application may send a request to a cloud server for an uncorrupt copy of the media asset. The cloud server, in response to receiving the request, may send a query to all the remote devices connected to the cloud server asking for content information of their respective storage mediums (e.g., storage 408). The remote devices, in response to receiving the query from the cloud server, may transmit content information to the cloud server. For example, the remote devices may transmit the titles of the media assets and the times and dates that were stored on their respective storage mediums. The cloud server may store the incoming content information received from the plurality of remote devices into a database.

The media guidance application, in response to determining that the first segment is corrupt, may search the database storing the content information received from the plurality of remote devices to identify a remote device having a second copy of the media asset. For example, the media guidance application may identify the remote device 116 having a second copy of the movie “The Godfather” stored in its storage medium by searching the content information stored in the database.

At 916, in response to identifying the remote device, the media guidance application, implemented on control circuitry 404, may request a second segment of a plurality of segments corresponding to a second copy of the media asset where the second segment corresponds to an uncorrupt version of the first segment. For example, the media guidance application may identify the remote device 116 as having a second copy of the movie “The Godfather” stored thereon. The media guidance application may request an uncorrupt second segment 122 beginning at the playback position 108 (30-minute mark) corresponding to the corrupt first segment 118 beginning at the playback position 104 (30-minute mark). The media guidance application may make the request for the second segment 122 over a network connection (e.g., network connection 112). Moreover, the media guidance application, implemented on control circuitry 404, may receive the second segment 122 over the network connection 112.

At 918 the media guidance application, implemented on control circuitry 404, replaces the corrupt first segment at the first device with the second segment in the first copy of the media asset. For example, the media guidance application may edit the first copy of the media asset to remove a corrupt first segment 118 (e.g., beginning at playback position 104 of the movie “The Godfather”) and insert the second segment 122 corresponding to the first segment 118 (e.g., beginning at the playback position 108) in the first copy of the media asset at the first device 114.

At 920, the media guidance application, implemented on control circuitry 404, may generate for display the first copy of the media asset where the first segment 118 has been replaced by the second segment 122. For example, the media guidance application may generate for display on a display screen (e.g., display 412) connected to the media guidance application, a second segment of the media asset (e.g., second segment 122 beginning at playback position 108) in the first copy of the media asset on the first device 114.

It will be evident to a person skilled in the art that the steps described above with reference to FIG. 9 could be performed by any other devices shown in FIGS. 4 and 5. For example, process 900 may be performed by control circuitry 404 as instructed by a media guidance application on user equipment 502, 504, 506, first device 114, or remote device 116 in order to play back media. In addition, one or more steps of process 900 may be incorporated into or combined with one or more steps of any other process or embodiment (e.g., processes 600, 700, and 800).

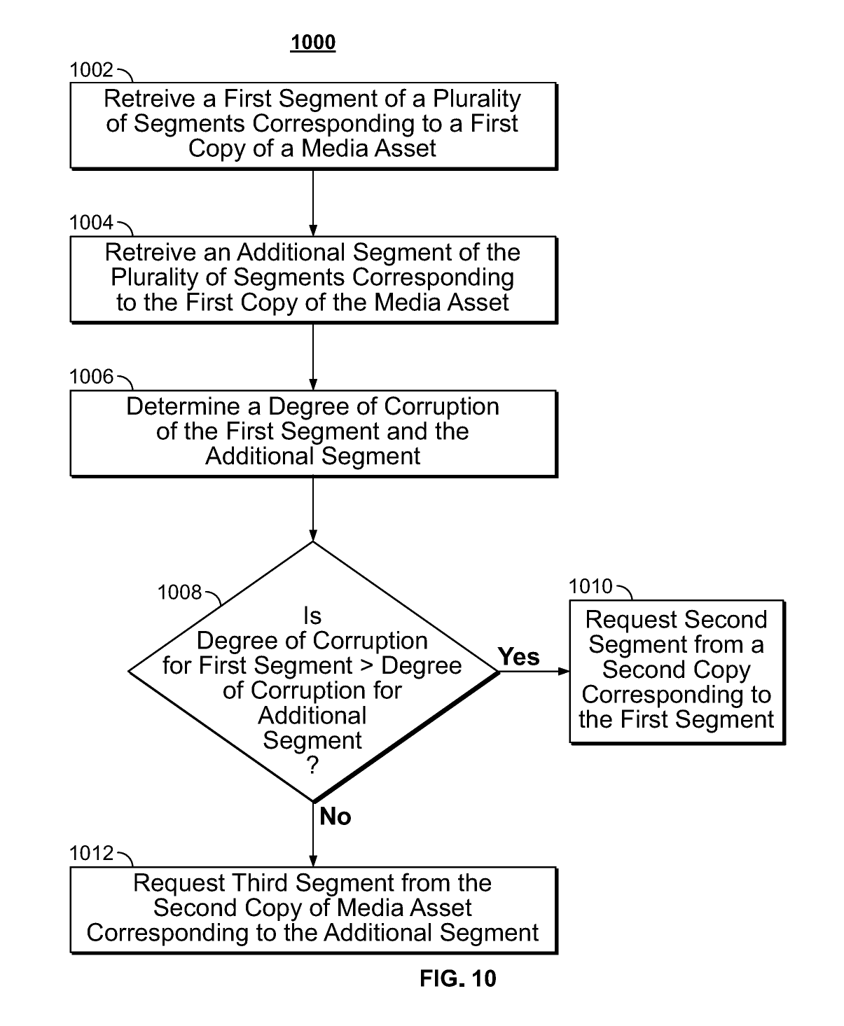

FIG. 10 depicts a flowchart of illustrative steps for playing back media at a user equipment device, such as the first device 114, in accordance with the present disclosure. Particularly, FIG. 10 depicts a flowchart for identifying and replacing a corrupt segment of a media asset at the first device with an uncorrupt segment from a remote device 116. At 1002, the media guidance application, via control circuitry 404, retrieves a first segment of a plurality of segments corresponding to a first copy of the media asset from a storage medium (e.g., storage 408). For example, the media guidance application may retrieve a first segment 118 of the plurality of segments corresponding to the first copy of the movie “The Godfather” from a storage medium on the first device 114.

At 1004, the media guidance application, via control circuitry 404, retrieves an additional segment of a plurality of segments corresponding to a first copy of the media asset from a storage medium (e.g., storage 408). For example, the media guidance application may retrieve an additional segment (e.g., segment beginning at the 60-minute mark) of the plurality of segments corresponding to the first copy of the movie “The Godfather” from a storage medium on the first device 114.

At 1006, the media guidance application, via control circuitry 404, may determine a degree of corruption of the first segment and a degree of corruption of the additional segment. For example, the media guidance application may calculate a degree of corruption of the first segment by comparing a calculated size of the first segment to the calculated average size of the segments in each of the additional copies of the media asset corresponding to the first segment. The media guidance application may calculate the size of the first segment. For example, the media guidance application, via the control circuitry 404 may read a header of the segment which includes a character count indicating the number of bytes in the segment. In some embodiments, control circuitry 404 may calculate the size of the segment by using information regarding the resolution and color depth of the video segment. For example, the segment size may be calculated using equation (1):

segment size (bytes)=total no. of pixels×color depth (bytes) (1).

The media guidance application, via control circuitry 404, may calculate an average size of segments of the additional copies of the media asset corresponding to the first segment. For example, the media guidance application may transmit a query to a cloud server connected to the media guidance application via a first device and connected to a plurality of remote devices. The cloud server, in response to receiving the query from the first device, may identify one or more remote devices storing additional copies of the media asset, in accordance with examples discussed above and below. The cloud server, via control circuitry 404, may calculate the respective sizes of the segments in the additional copies of the media asset corresponding to the first segment. Subsequently, the media guidance application, via control circuitry 404, may calculate an average size of a segment in each additional copy of the media asset that corresponds to the first segment. The media guidance application, via control circuitry 404, may determine a degree of corruption of the first segment by comparing the calculated size of the first segment and the calculated average size of the segments of the additional copies of the media asset corresponding to the first segment.

Moreover, the media guidance application may determine the size of the additional segment. For example, the media guidance application, via the control circuitry 404 may read a header of the additional segment which includes a character count indicating the number of bytes in the additional segment. In some embodiments, control circuitry 404 may calculate the size of the additional segment by using information regarding the resolution and color depth of the video segment. For example, the segment size may be calculated using equation (1). The media guidance application, via control circuitry 404, may calculate an average size of segments of the additional copies of the media asset corresponding to the additional segment. For example, the media guidance application may transmit a query to a cloud server connected to the media guidance application via a first device and connected to a plurality of remote devices. The cloud server, in response to receiving the query from the first device, may identify one or more remote devices storing additional copies of the media asset, in accordance with examples discussed above and below. The cloud server, via control circuitry 404, may calculate the respective sizes of the segments in the additional copies of the media asset corresponding to the additional segment. Subsequently, the media guidance application, via control circuitry, may calculate an average size of a segment in each additional copy of the media asset that corresponds to the additional segment. The media guidance application, via control circuitry 404, may determine a degree of corruption of the additional segment by comparing the calculated size of the additional segment and the calculated average size of the segments of the additional copies of the media asset corresponding to the additional segment.

At 1008, the media guidance application, via the control circuitry 404, may compare the degree of corruption of the first segment to the degree of corruption of the additional segment. For example, the media guidance application may determine that the first segment is more corrupt than the additional segment of the plurality of segments corresponding to the first copy of the media asset and proceed to 1010. At 1010, in response to determining that the degree of corruption of the first segment is greater than the degree of corruption of the additional segment, the media application guidance, implemented on control circuitry 404, may search a database listing a plurality of remote devices that have copies of the media asset to identify a remote device having a second copy of the media asset.

For example, the media guidance application may search a database hosted on a cloud server that stores the contents of storage mediums (e.g., storage 408) of each of the remote devices connected to the cloud server (e.g., network connection 112). In some embodiments, the media guidance application may send a request to a cloud server for an uncorrupt copy of the media asset. The cloud server, in response to receiving the request, may send a query to all the remote devices connected to the cloud server asking for content information of their respective storage mediums (e.g., storage 408). The remote devices, in response to receiving the query from the cloud server, may transmit content information to the cloud server. For example, the remote devices may transmit the titles of the media assets and the times and dates that were stored on their respective storage mediums. The cloud server may store the incoming content information received from the plurality of remote devices into a database.

The media guidance application, in response to determining that the first segment more is corrupt, may search the database storing the content information received from the plurality of remote devices to identify a remote device having a second copy of the media asset. For example, the media guidance application may identify the remote device 116 having a second copy of the movie “The Godfather” stored in its storage medium by searching the content information stored in the database. In response to identifying the remote device, the media guidance application, implemented on control circuitry 404, may request a second segment of a plurality of segments corresponding to a second copy of the media asset where the second segment corresponds to an uncorrupt version of the first segment. For example, the media guidance application may identify the remote device 116 as having a second copy of the movie “The Godfather” stored thereon. The media guidance application may request an uncorrupt second segment 122 beginning at the playback position 108 (30-minute mark) corresponding to the corrupt first segment 118 beginning at the playback position 104 (30-minute mark). The media guidance application may make the request for the second segment 122 over a network connection (e.g., network connection 112). Moreover, the media guidance application, implemented on control circuitry 404, may receive the second segment 122 over the network connection 112.

The media guidance application, implemented on control circuitry 404, replaces the corrupt first segment at the first device with the second segment in the first copy of the media asset. For example, the media guidance application may edit the first copy of the media asset to remove a corrupt first segment 118 (e.g., beginning at playback position 104 of the movie “The Godfather”) and insert the second segment 122 corresponding to the first segment 118 (e.g., beginning at the playback position 108) in the first copy of the media asset at the first device 114. The media guidance application, implemented on control circuitry 404, may generate for display the first copy of the media asset where the first segment 118 has been replaced by the second segment 122. For example, the media guidance application may generate for display on a display screen (e.g., display 412) connected to the media guidance application, a second segment of the media asset (e.g., second segment 122 beginning at playback position 108) in the first copy of the media asset on the first device 114.

At 1008, the media guidance application may determine that the first segment is not more corrupt than the additional segment of the plurality of segments corresponding to the first copy of the media asset and proceed to 1012. At 1012, in response to determining that the degree of corruption of the first segment is not greater than the degree of corruption of the additional segment, the media guidance application, implemented on control circuitry 404, may search a database listing a plurality of remote devices that have copies of the media asset to identify a remote device having a second copy of the media asset. For example, the media guidance application may search a database hosted on a cloud server that stores the contents of storage mediums (e.g., storage 408) of each of the remote devices connected to the cloud server (e.g., network connection 112). In some embodiments, the media guidance application may send a request to a cloud server for an uncorrupt copy of the media asset. The cloud server, in response to receiving the request, may send a query to all the remote devices connected to the cloud server asking for content information of their respective storage mediums (e.g., storage 408). The remote devices, in response to receiving the query from the cloud server, may transmit content information to the cloud server. For example, the remote devices may transmit the titles of the media assets and the times and dates that were stored on their respective storage mediums. The cloud server may store the incoming content information received from the plurality of remote devices into a database.

The media guidance application, in response to determining that the additional segment is more corrupt than the first segment, may search the database storing the content information received from the plurality of remote devices to identify a remote device having a second copy of the media asset. For example, the media guidance application may identify the remote device 116 having a second copy of the movie “The Godfather” stored in its storage medium by searching the content information stored in the database.

In response to identifying the remote device, the media guidance application, implemented on control circuitry 404, may request a third segment of a plurality of segments corresponding to a second copy of the media asset where the third segment corresponds to an uncorrupt version of the additional segment. For example, the media guidance application may identify the remote device 116 as having a second copy of the movie “The Godfather” stored thereon. The media guidance application may request an uncorrupt third segment beginning at the playback position starting at, for example, the 60-minute mark corresponding to the corrupt additional segment beginning at the playback position starting at, for example, the 60-minute mark. The media guidance application may make the request for the third segment over a network connection (e.g., network connection 112). Moreover, the media guidance application, implemented on control circuitry 404, may receive the third segment over the network connection 112.

The media guidance application, implemented on control circuitry 404, may replace the corrupt additional segment at the first device with the third segment in the first copy of the media asset. For example, the media guidance application may edit the first copy of the media asset to remove a corrupt additional segment (e.g., beginning at the 60-minute mark of the movie “The Godfather”) and insert the third segment corresponding to the additional segment in the first copy of the media asset at the first device 114.

The media guidance application, implemented on control circuitry 404, may generate for display the first copy of the media asset where the additional segment has been replaced by the third segment. For example, the media guidance application may generate for display, on a display screen (e.g., display 412) connected to the media guidance application, a third segment of the media asset in the first copy of the media asset on the first device 114.

Although the description of the above embodiments reference replacing a corrupt segment of the plurality of segments corresponding to a first copy of the media asset with an uncorrupt version of the corrupt segment, it will be evident to a person possessing ordinary skill in the art that the disclosure is not so limited. For example, in some embodiments, both the first segment in the first copy of the media asset stored in a memory storage of the first device and the second segment in a second copy of the media asset stored in a memory storage of a remote device are corrupt. The media guidance application, via control circuitry 404, may calculate a degree of corruption of the first segment and the second segment in accordance with the methods and processes discussed above. In response to determining that the second segment of the second copy of the media asset stored in the memory storage of the remote device is more corrupt than the first segment of the plurality of segments corresponding to the first copy of the media asset, the media guidance application may determine that the first segment should not be replaced. Conversely, in response to determining that the second segment of the second copy of the media asset stored in the memory storage of the remote device is less corrupt than the first segment of the plurality of segments corresponding to the first copy of the media asset, the media guidance application may determine that the first segment should be replaced by the second segment using one or more processes discussed above.

In some embodiments, the media guidance application may determine that the first segment is corrupt by determining that the first segment is missing a program clock reference (PCR) or a presentation time stamp (PTS). The media guidance application may also determine that the first segment is corrupt by determining an out of sequence continuity counter. In some embodiments, the media guidance application may determine that the first segment is corrupt by obtaining a transport error indicator.

In some embodiments, the media guidance application may determine performance capabilities of a communication channel used by the first device for communication to the remote device. For example, the media guidance application may perform network tests such as a ping test or a download/upload test to determine a network latency and throughput. The media guidance application may determine an encoding parameter based on the performance capabilities. For example, the media guidance application may determine that a network is slow (e.g., a measured throughput of the network is less than a threshold minimum value for network speed). In response to determining that the network is slow, the media guidance application may determine an encoding parameter that increases encoding compressing to minimize the throughput requirement necessary to transmit the encoded media.

In some embodiments, the media guidance application may transmit, from the remote device to the first device, a segment of the second copy of the media asset encoded in the encoding format based on the encoding parameter. For example, the media guidance application may transmit from the remote device to the first device the segment, wherein the segment is encoded, at the remote device, in the mutually compatible encoding format using the encoding parameter (e.g., compression level as described above).

In some embodiments, the media guidance application may negotiate a transfer configuration with the remote device. For example, the media guidance application may negotiate encoding parameters between the media guidance application and the remote device to maximize a quality of a stream based on the capabilities of both devices. For example, the media guidance application may transmit a query (e.g., to a database listing the capabilities of the remote device or to the remote device) to request a format of the second segment and/or encoding capabilities of the remote device. For example, in response to the query transmitted by the media guidance application, the media guidance application may receive a response (e.g., from the database or from the remote device) containing a list of formats the remote device can encode (e.g., VP9, Dirac, H.264, VC-1 etc.) and a file format or encoding format of the second segment of the media asset (e.g., MPEG, H.262, WebM, MKV etc.).

In some embodiments, the media guidance application, via control circuitry 404, may test performance capabilities of a communication network utilized by the media guidance application to communicate with the remote device. For example, the media guidance application may conduct a network test (e.g., a network ping test to test latency or a download/upload test to test throughput) between the remote device and the media guidance application. The media guidance application may use the results of the test to determine an encoding parameter for the second and/or third segments. For example, the media guidance application may determine that maximum upload throughput of the remote device is 15 Mbps and that the maximum download throughput of the media guidance application is 20 Mbps. The media guidance application may use the performance capabilities of the network to modify the encoding of the second and/or third segments for transmission over the network.

In some embodiments, the media guidance application may identify an encoding parameter based on the performance capabilities. For example, the media guidance application may determine a frame rate, resolution, encoding format, etc., for the second and/or third segments such that a bandwidth requirement for transmitting the second and/or third segments from the remote device to the first device does not exceed the measured upload throughput of the remote device (15 Mbps).

In some embodiments, the media guidance application may transfer, from the remote device to the first device, a segment of the second copy of the media asset encoded in the encoding format based on the encoding parameter. For example, the media guidance application may transmit a query to the remote device to request second and/or third segments in the encoding format (e.g., MPEG-4) based on the encoding parameter (e.g., bandwidth less than 15 Mbps and/or resolution of 1080p).

In some embodiments, the media guidance application may retrieve, from a memory storage, a profile for a user of the first device. The media guidance application may identify the media display preferences corresponding to the user based on the profile. For example, the media guidance application may determine, based on the user profile, that the user always watches movies on a tablet and not a television. Based on the media display preferences, the media guidance application may determine an encoding parameter and transmit the encoding parameter to the remote device, when requesting an uncorrupt version of a corrupt segment on the first device. The remote device, in response to receiving the encoding parameter, may transmit the second segment to the first device encoded in a desired format based on the encoding parameter.

In some embodiments, the first segment and the second segment may each include time stamp information. The media guidance application may replace, at the first device, the first segment with the second segment in the first copy of the media asset based on the time stamp information.

In some embodiments, the program content providers may specify a limitation on copying the program. For example, a program content provider may specify that the program may only be copied once (a “copy once” flag), never copied (a “copy never” flag), or that the program may be copied freely (a “copy freely” flag). A person possessing ordinary skill in the art will understand that a user equipment may request a segment of a program from another remote user equipment to repair a corrupted frame, while taking into consideration the appropriate program sharing limitations. For example, the user equipment, upon determining that the program content provider has specified a “copy once” flag for the desired program may only transmit uncorrupted segments to another device once.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiments herein, and flowcharts or examples relating to any one embodiment may be combined with any other embodiments in a suitable manner, done in different orders, or done in parallel. Furthermore, it should be noted that while a first step may be based on and/or in response to a second step, such a relationship does not preclude additional steps occurring between the first and second steps. In addition, the systems and methods described herein may be performed in real time. It should also be noted the systems and/or methods described above may be applied to, or used in accordance with, other systems and/or methods.

1. A method for providing uncorrupt media assets, the method comprising:
retrieving, at a first device, a first segment of a plurality of segments corresponding to a first copy of a media asset from a memory;
determining, at the first device, whether the first segment is corrupt;
in response to determining that the first segment is corrupt, searching a database listing a plurality of remote devices that have copies of the media asset to identify a remote device having a second copy of the media asset; and
in response to identifying the remote device, requesting a second segment of a plurality of segments corresponding to a second copy of the media asset, wherein the second segment corresponds to an uncorrupt version of the first segment;
receiving, at the first device, the second segment from the remote device;
replacing, at the first device, the first segment with the second segment in the first copy of the media asset; and
generating for display, at the first device, the first copy of the media asset, wherein the first segment is replaced with the second segment.

2. The method of claim 1, wherein determining that the first segment is corrupt comprises:
computing a checksum of the first segment;
comparing the computed checksum to a checksum value corresponding to the first segment; and
determining that the first segment is corrupt when the computed checksum differs from the checksum value associated with the first segment.

3. The method of claim 1, wherein determining that the first segment is corrupt comprises:
calculating a first hash value corresponding to the first segment;
comparing the first hash value to a hash value corresponding to the first segment; and
determining that the first segment is corrupt when the first hash value differs from the hash value associated with the first segment.

4. The method of claim 1, wherein determining that the first segment is corrupt comprises:
determining that the first segment is missing a program clock reference stamp or a presentation time stamp, determining an out of sequence continuity counter, or obtaining a transport error indicator.

5. The method of claim 1, wherein determining that the first segment is corrupt comprises:
calculating a size of the first segment of the first copy of the media asset;
calculating an average size of a segment in each additional copy of the media asset which corresponds to the first segment of the first copy of the media asset;
determining that the first segment is corrupt when the size of the first segment differs from the average size.

6. The method of claim 1, further comprising:
retrieving, at the first device, an additional segment of the plurality of segments corresponding to the first copy of the media asset;
determining that the additional segment is corrupt;
comparing a degree of corruption of the additional segment to a degree of corruption of the first segment; and
in response to determining that the degree of corruption of the additional segment is more than the degree of corruption of the first segment, requesting a third segment of the plurality of segments corresponding to the second copy of the media asset and not requesting the second segment, wherein the third segment corresponds to an uncorrupt version of the additional segment.

7. The method of claim 1, wherein
the second segment of the plurality of segments corresponding to the second copy of the media asset is corrupt; and
a degree of corruption of the second segment is less than a degree of corruption of the first segment.

8. The method of claim 1, further comprising:
retrieving, from the memory, a profile for a user of the first device;
identifying, based on the profile, media display preferences corresponding to the user;
determining an encoding parameter based on the media display preferences corresponding to the user;
transmitting, to the remote device, the encoding parameter; and
receiving, from the remote device, the second segment encoded in a first format based on the encoding parameter.

9. The method of claim 1, wherein the first segment and the second segment each include time stamp information, and replacing, at the first device, the first segment with the second segment in the first copy of the media asset further comprises:
replacing the first segment with the second segment based on the time stamp information.

10. The method of claim 1, wherein receiving, at the first device, the second segment from the remote device further comprises:
receiving the second segment from the remote device in a first format at the first device, wherein the second segment was re-encoded, at the remote device, from a second format for streaming over a network connection between the first device and the remote device,
wherein the second segment is re-encoded to at least one of a lower segment rate or lower resolution than a respective segment rate or respective resolution of the first segment.

11. A system for providing uncorrupt media assets, the system comprising:
memory configured to store a first copy of a media asset; and
control circuitry configured to:
retrieve a first segment of a plurality of segments corresponding to the first copy of the media asset stored in memory;
determine whether the first segment is corrupt;
search a database listing a plurality of remote devices that have copies of the media asset to identify a remote device having a second copy of the media asset in response to determining that the first segment is corrupt; and
request a second segment of a plurality of segments corresponding to a second copy of the media asset, wherein the second segment corresponds to an uncorrupt version of the first segment in response to identifying the remote device;
receive the second segment from the remote device;
replace the first segment with the second segment in the first copy of the media asset; and
generate for display the first copy of the media asset, wherein the first segment is replaced with the second segment.

12. The system of claim 11, wherein the control circuitry is further configured to determine that the first segment is corrupt by:
computing a checksum of the first segment;
comparing the computed checksum to a checksum value corresponding to the first segment; and
determining that the first segment is corrupt when the computed checksum differs from the checksum value associated with the first segment.

13. The system of claim 11, wherein the control circuitry is further configured to determine that the first segment is corrupt by:
calculating a first hash value corresponding to the first segment;
comparing the first hash value to a hash value corresponding to the first segment; and
determining that the first segment is corrupt when the first hash value differs from the hash value associated with the first segment.

14. The system of claim 11, wherein the control circuitry is further configured to determine that the first segment is corrupt by:
determining that the first segment is missing a program clock reference stamp or a presentation time stamp, determining an out of sequence continuity counter, or obtaining a transport error indicator.

15. The system of claim 11, wherein the control circuitry is further configured to determine that the first segment is corrupt by:
calculating a size of the first segment of the first copy of the media asset;
calculating an average size of a segment in each additional copy of the media asset which corresponds to the first segment of the first copy of the media asset;
determining that the first segment is corrupt when the size of the first segment differs from the average size.

16. The system of claim 11, wherein the control circuitry is further configured to:
retrieve, at the first device, an additional segment of the plurality of segments corresponding to the first copy of the media asset;
determine that the additional segment is corrupt;
compare a degree of corruption of the additional segment to a degree of corruption of the first segment; and
in response to determining that the degree of corruption of the additional segment is more than the degree of corruption of the first segment, request a third segment of the plurality of segments corresponding to the second copy of the media asset and not requesting the second segment, wherein the third segment corresponds to an uncorrupt version of the additional segment.

17. The system of claim 11, wherein:
the second segment of the plurality of segments corresponding to the second copy of the media asset is corrupt; and
a degree of corruption of the second segment is less than a degree of corruption of the first segment.

18. The system of claim 11, wherein the control circuitry is further configured to:
retrieve, from the memory, a profile for a user of the first device;
identify, based on the profile, media display preferences corresponding to the user;
determine an encoding parameter based on the media display preferences corresponding to the user;
transmit, to the remote device, the encoding parameter; and
receive, from the remote device, the second segment encoded in a first format based on the encoding parameter.

19. The system of claim 11, wherein the first segment and the second segment each include time stamp information, and wherein the control circuitry configured to replace the first segment with the second segment in the first copy of the media asset is further configured to replace the first segment with the second segment based on the time stamp information.

20. The system of claim 11, wherein the control circuitry configured to receive the second segment from the remote device is further configured to receive the second segment from the remote device in a first format at the first device, wherein the second segment was re-encoded from a second format for streaming over a network connection between the first device and the remote device.

21.-50. (canceled)
